(19) United States
(12) Patent Application Publication
(10) Pub. No.: US 2021/0117307 A1
(43) Pub. Date: Apr. 22, 2021

(54) AUTOMATED VERIFICATION OF PLATFORM CONFIGURATION FOR WORKLOAD DEPLOYMENT

(71) Applicants: Chris M. MacNamara, Ballyclough (IE); John J. Browne, Limerick (IE); Amruta Misra, Bangalore (IN); David Hunt, Meelick (IE); Niall C. Power, Limerick (IE); Tomasz Kantecki, Ennis (IE); Dave Cremins, Limerick (IE)

(72) Inventors: Chris M. MacNamara, Ballyclough (IE); John J. Browne, Limerick (IE); Amruta Misra, Bangalore (IN); David Hunt, Meelick (IE); Niall C. Power, Limerick (IE); Tomasz Kantecki, Ennis (IE); Dave Cremins, Limerick (IE)

(21) Appl. No.: 17/134,357

(22) Filed: Dec. 26, 2020

(51) Int. Cl. G06F 11/36; G06F 1/28; G06F 9/50; G06F 9/445; G06F 11/34; G06F 11/30

(52) U.S. Cl. CPC G06F 11/3612; G06F 11/3664; G06F 11/3688; G06F 11/302; G06F 9/505; G06F 9/44505; G06F 11/3433; G06F 1/28

(57) ABSTRACT

In one embodiment, a computing device includes processing circuitry to receive a request to evaluate a plurality of platform configurations for deployment of an application workload on a compute platform, wherein the application workload is to be deployed based on one or more workload requirements; deploy a representative workload on the compute platform based on the plurality of platform configurations, wherein the representative workload is representative of the application workload; obtain performance data for the plurality of platform configurations, wherein the performance data is obtained based on deploying the representative workload on the compute platform; and determine, based on the performance data, whether the plurality of platform configurations satisfy the one or more workload requirements.

### BACKGROUND

The compute platforms in a data center are typically manually provisioned and managed by a system administrator. For example, a system administrator may manually provision and configure a platform for a particular workload, observe the performance of the platform at runtime, and troubleshoot problems that arise on the platform. This manual approach can be tedious, time consuming, and error prone.

### BRIEF DESCRIPTION OF THE DRAWINGS

FIG. 1 illustrates an example embodiment of a workload deployment lifecycle that automatically verifies the platform configuration used to deploy a workload.

FIGS. 2-3 illustrate examples of various processor frequency scaling modes.

FIG. 4 illustrates a flowchart for automatically verifying platform configurations for a workload deployment in accordance with certain embodiments.

FIG. 5 illustrates an example of a multi-core processor platform in accordance with certain embodiments.

FIG. 6 illustrates an example of a server computing platform in accordance with certain embodiments.

FIG. 7 illustrates deployment of a virtual edge configuration in an edge computing system operated among multiple edge nodes and multiple tenants.

FIG. 8 illustrates various compute arrangements deploying containers in an edge computing system.

FIG. 9 illustrates an example mobile edge system reference architecture, arranged according to an ETSI Multi-Access Edge Computing (MEC) specification.

### DETAILED DESCRIPTION

The compute platforms in a data center are typically provisioned and managed manually by a system administrator (sysadmin). For example, when adding a new compute platform to a cluster in a data center, the sysadmin may manually provision the platform using Basic Input/Output System (BIOS) configuration controls, software agents, software application programming interfaces (APIs) (e.g., software-defined infrastructure (SDI) and/or software-defined data center (SDDC) APIs, such as Redfish), platform management systems, and so forth. After provisioning the compute platform, a workload may be deployed on the platform and the sysadmin may manually observe or monitor its performance (e.g., by reviewing the workload status, resource utilization, performance metrics, configuration files, and so forth). If any problems or irregularities are identified (e.g., instability, platform issues, software issues, configuration issues), the sysadmin may then manually assess the root cause of those problems and perform any appropriate remedial actions.

This approach has various disadvantages, as it often requires a high degree of human intervention. For example, there is no automated mechanism to verify whether the platform configuration is suitable for a particular workload prior to deploying the workload. Moreover, when problems arise on the platform, “root causing” the problems is a manual process—there is no automatic process for provisioning, observing, and assessing the platform and software at runtime. There is also no automatic mechanism for the orchestration system (e.g., Kubernetes, OpenStack) to re-check or re-apply configurations at runtime without evacuating workloads from the platform.

As a result, many operational issues may arise when workloads are deployed on incorrectly provisioned platforms (e.g., platforms that are misconfigured and/or lack the requisite hardware components), such as outages due to evacuations and rollbacks of workloads/configurations, lengthy debug sessions, 24×7 troubleshooting callouts, and so forth. In some cases, these outages can have significant business and financial consequences. As an example, for a telecommunications service provider, an outage may leave millions of customers without phone service for an extended period of time, resulting in millions of dollars in repair costs, damage to the company's reputation, loss of customers, and so forth.

Further, in view of the numerous tuning knobs that can impact workload performance, it can be difficult to deploy new technologies on a platform (e.g., new CPU features) for workloads with strict performance requirements (e.g., real-time, low-latency workloads), as the performance impact of those technologies is unknown.

Accordingly, this disclosure presents various embodiments for automatically verifying the platform configuration used to deploy a workload. These embodiments enable platforms to be automatically configured and tuned in a more consistent and reliable manner to ensure that the appropriate level of performance is achieved for any given workload. In this manner, the degree of manual human intervention involved in the workload deployment lifecycle is reduced, which reduces the potential for errors and misconfigured platforms that often lead to performance reductions, downtime, and/or service outages.

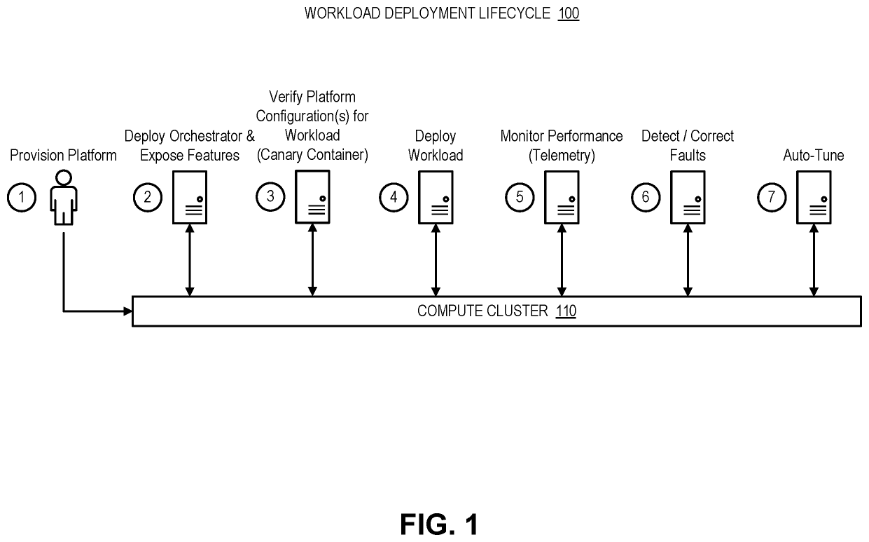

FIG. 1 illustrates an example embodiment of a workload deployment lifecycle 100 that automatically verifies the platform configuration used to deploy a workload. In the illustrated embodiment, for example, the configuration of a compute platform is automatically verified prior to deploying a live workload on the platform, as explained further below.

In particular, deployment lifecycle 100 includes the following steps:
(1) Platform Provisioning: A new compute platform for a data center cluster 110 is provisioned by a sysadmin;
(2) Feature Exposure: An orchestration system (e.g., Kubernetes, Docker Swarm, and/or any other orchestration software) is installed/deployed on the compute platform and exposes the features available on the platform;
(3) Automated Verification of Platform Configuration: A canary container with a representative workload is deployed on the compute platform (e.g., by the orchestration system) to automatically evaluate/verify platform configurations that are suitable for live workload deployments on the platform;
(4) Workload Deployment: The orchestration system deploys live workloads on the compute platform based on verified configurations of the platform (and similarly on other platforms in the cluster 110);
(5) Performance Monitoring: The platform and workloads are monitored at runtime to collect telemetry and/or performance data;
(6) Fault Detection/Correction: Faults are detected (e.g., unhealthy states of the platform or workloads), and appropriate remedial actions are taken to correct or address the faults (e.g., scaling/healing the platform or workloads); and
(7) Auto-Tuning/Runtime Optimizations: The platform is automatically tuned at runtime to achieve optimal performance (e.g., based on the telemetry/performance data).

The step of automatically verifying the platform configuration—which is referenced above as step three of deployment lifecycle 100—is a novel step that addresses the pain points of workload deployment (e.g., configuration, performance, operations, automation). In particular, this step automatically verifies the configuration of a compute platform prior to deploying a live workload on the platform, thus ensuring that the platform configuration is capable of satisfying the workload requirements before the workload is deployed.

For example, each workload deployed on a cluster of compute platforms in a computing infrastructure typically has a unique set of requirements, such as performance requirements, resource requirements, workload dependencies, and so forth. In some cases, for example, some or all of the workload requirements may be specified in a workload profile and/or a service level agreement (SLA) between the infrastructure provider and the workload owner/tenant.

For example, the performance requirements may specify threshold levels for various performance metrics or key performance indicators (KPIs) that should be satisfied when the workload is deployed, such as power consumption, latency, network bandwidth, core frequency (e.g., a guaranteed minimum frequency), and so forth. The resource requirements may specify the computing resources that are required to run the workload, such as the type, number, and/or capacity of various physical and/or logical resources required for the workload deployment (e.g., CPUs, GPUs, processing cores or processing units, virtual machines, memory capacity, network bandwidth). The workload dependencies may specify various dependencies or requirements associated with the workload, the underlying tasks of the workload, and/or any other related or dependent workloads, including any platform or resource-specific technologies required by the workload (e.g., Intel® Speed Select, Turbo Boost, and/or Resource Director Technology).

Moreover, each compute platform in a cluster typically has numerous configurable tuning knobs or parameters that can impact the performance of a workload, such as the host system configuration (e.g., central processing unit (CPU) configuration), operating system (OS) kernel configuration, VM configuration, isolation techniques, and so forth.

For example, a host CPU typically supports multiple power configurations or modes that can be configured to provide optimal performance for a particular workload (e.g., based on the workload type, use case, and/or requirements), such as P-states, C-states, frequency boosting and scaling modes, and so forth. These power configurations are typically used to increase processing performance and speed, reduce power consumption, or provide some balance between processing performance and power consumption for a particular workload or group of workloads running on the platform.

For example, a processor (e.g., CPU) may support various power performance states that can be configured to control the desired performance of the processor, which are commonly referred to as “P-states.” The various P-states can be configured to scale the frequency and/or voltage of the processor and/or processor cores up or down (e.g., to improve performance or reduce power consumption).

A processor (e.g., CPU) may also support various idle or sleep states that can be configured to control the level of sleep that the processor and/or processor cores enter when they are idle, which are commonly referred to as “C-states.” C-states typically range from “shallow” states where a configured component is completely awake (e.g., a fully powered core actively executing instructions) to “deep” states where the configured component is completely asleep (e.g., an idle core that is powered off).

The respective P-states and C-states may be beneficial for some workloads and problematic for others depending on the circumstances (e.g., workload requirements, runtime conditions). As an example, a low-latency workload may want to avoid entering a deep C-state due to the longer exit/response time.

A processor (e.g., CPU) may also support a variety of other power modes, configurations, and/or parameters, including (among other examples):
(i) dynamic voltage and frequency scaling (DVFS) modes to dynamically scale the voltage/frequency of the processor and/or processor cores based on runtime conditions (e.g., workloads currently running on the processor, workload requirements, current resource utilizations);
(ii) uncore frequency scaling (UFS) modes to scale the frequency/voltage of “uncore” processor components, or components of the processor other than the cores, such as processor caches (e.g., a last level cache (LLC)), memory controllers, interconnect controllers, and I/O controllers;
(iii) advanced vector extensions (AVX) power levels (e.g., for AVX/SIMD processing units, co-processors, or accelerators); and
(iv) network interface controller (NIC) configuration parameters.

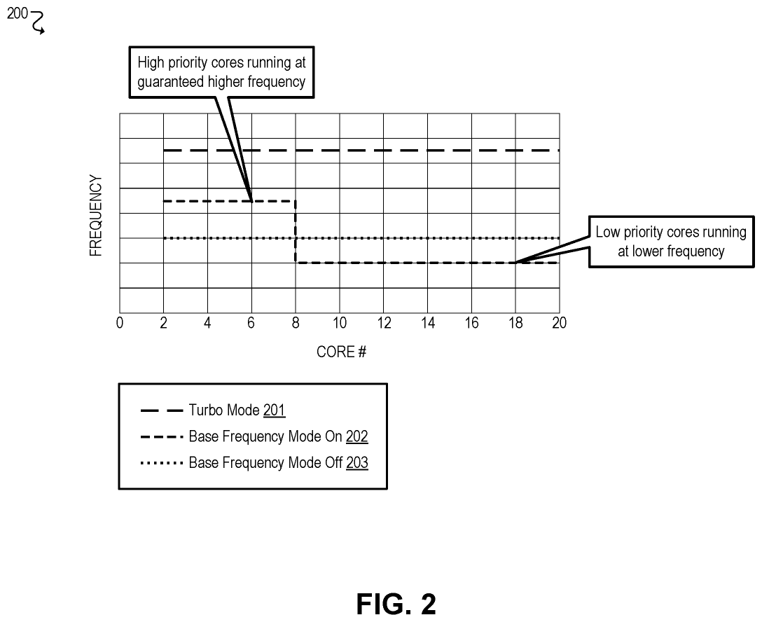

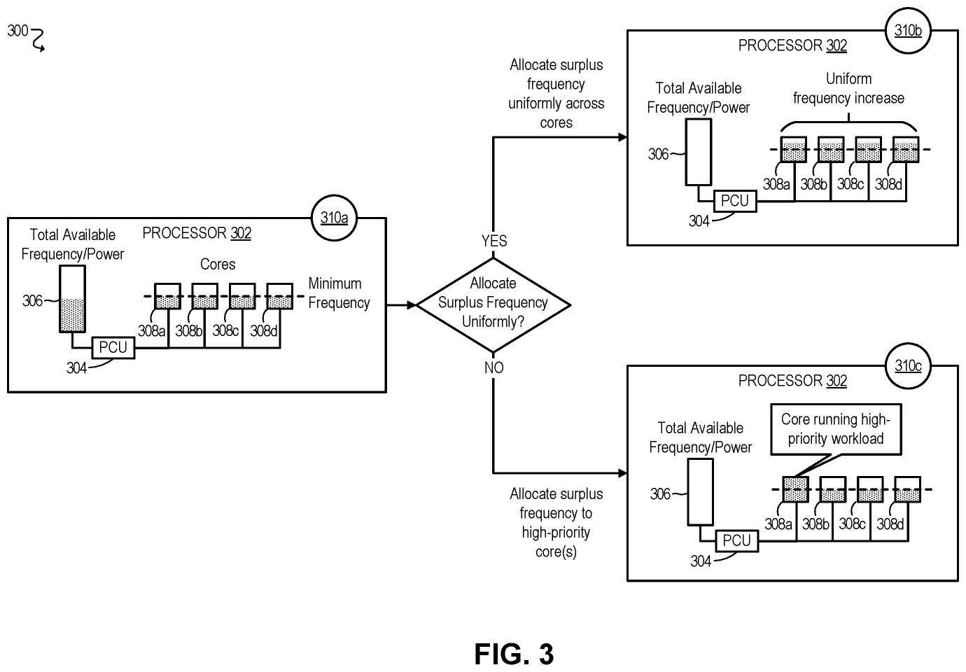

Various processor frequency scaling modes are presented as examples and described in further detail in connection with FIGS. 2-3.

These power modes provide more granular control over a processor (e.g., a CPU) for optimal performance, as cores running the most critical workloads can be prioritized and operated at higher frequencies when needed. As an example, these power modes could be leveraged to dynamically boost the performance of virtual network functions (VNFs) whenever there are large spikes in network traffic.

However, these power modes are typically pre-provisioned, configured, or selected on a platform before each workload is launched or deployed. As a result, it can be challenging to verify whether the optimal power mode was provisioned and properly configured until after the workload is deployed live on the platform and its behavior and performance can be observed.

Moreover, the universe of potential configurations of a compute platform can significantly impact the performance of workloads running on the platform. As a result, certain platform configurations may be unable to achieve the requisite level of performance for workloads with strict performance requirements, such as real-time or low-latency workloads.

Accordingly, in deployment lifecycle 100, various configurations of a compute platform are automatically evaluated prior to deploying a live workload on the platform to verify which configurations satisfy the requirements of the workload. In this manner, the platform can be configured using a verified configuration before the workload is deployed.

In some embodiments, for example, the various platform configurations are evaluated by deploying a representative workload on the platform under each configuration, monitoring the platform and/or workload performance under each configuration, and determining whether the observed performance under each configuration satisfies the requirements of the actual workload to be deployed on the platform.

The representative workload can include any workload or combination of workloads that stress the resources of the compute platform in a manner that is similar to, or representative of, the actual workload. In some cases, for example, the representative workload may consume a similar capacity of certain resources as the actual workload (e.g., power, processing capacity, memory capacity, network bandwidth).

In various embodiments, for example, the representative workload may include, or may be implemented by:
(i) various “canary” workloads and/or performance benchmarks (e.g., industry standard benchmarks such as cyclictest) that perform a variety of stress and/or performance tests designed to simulate the degree of stress exerted on the platform resources by the actual workload and/or measure the performance of the platform under the stressed conditions; and/or
(ii) the actual application workload deployed or configured in a test mode (e.g., using test data rather than live data).

In some embodiments, for example, the representative workload may include various stress and/or performance tests, or “stressors,” performed on the following types of platform resources and/or capabilities (among other examples):
(i) CPU cache (e.g., instruction cache, data cache);
(ii) CPU compute (e.g., bit manipulation, integer, float, double, string, search, hash, cyclic redundancy check (CRC), and/or Fast Fourier Transform (FFT) operations);
(iii) process management (e.g., process creation and termination, context switching, threads, inter-process communication (IPC) (e.g., pipes, shared memory, sempahores, mutexes));
(iv) devices (e.g., block storage);
(v) filesystem and I/O (e.g., files, attributes, directories, links, renaming);
(vi) interrupts (e.g., interrupt requests (IRQs) and soft interrupts);
(vii) memory (e.g., throughput, VM, RAM tests, paging, stack, data segment/program break, memory mapping);
(viii) networking (e.g., network bandwidth/throughput/latency, networking protocols);
(ix) kernel (e.g., system calls, system/process filesystem interfaces);
(x) virtual machines (VMs), containers, containers within VMs; and/or
(xi) security modes (e.g., program restrictions, isolation).

Moreover, as the stress tests are being performed, various performance metrics or KPIs are tracked in order to evaluate the platform performance under stressed conditions, such as interrupt performance (e.g., timer interrupt latency), packet and network related performance (e.g., packet latency/launch latency, packet/tail jitter, packets per second, packet loss, network/end-to-end latency, round trip time, maximum latency), compute performance, power-related performance (e.g., exit latency for power state transitions, power consumption (Watts), compute performance per watt), performance impact on other workloads deployed on the platform, and so forth.

In some embodiments, the stress and/or performance tests included in the representative workload may be implemented using one or more software packages or tools, such as stress-ng (e.g., to perform stress tests on a variety of platform resources), the Data Plane Development Kit (DPDK) (e.g., to perform packet transmission, loopback, and jitter tests), cyclictest (e.g., to perform timer/interrupt latency tests), and so forth.

Moreover, in some embodiments, the various software packages and/or tools used to implement the representative workload may be deployed in a software container (e.g., a Docker container), which may be referred to as a “canary container.” In this manner, the various platform configurations can be evaluated by deploying the canary container on the platform under each configuration, observing the performance of the platform and/or representative workload under each configuration, and verifying whether each configuration can satisfy the workload and/or SLA requirements based on the observed performance.

The canary container can then generate a report of the results, which may indicate (i) whether the platform is verified to be placed into a cluster or pool for live workload deployments, (ii) which platform configurations satisfy the workload and/or SLA requirements, (iii) which platform configurations provide optimal performance, and so forth. The report generated by the canary container can then be used to configure the compute platform using an optimal configuration, place the configured platform in a cluster or pool of the computing infrastructure, and/or deploy live workload(s) on the platform. In various embodiments, for example, this may be performed manually by a sysadmin, automatically by infrastructure management software (e.g., the orchestration system), or some combination of both.

In some cases, for example, the canary container could be used to automatically provision and configure a low-latency power-saving platform for workloads that require real-time responses and/or low-latency packet processing in an energy efficient manner, such as virtual network function (VNF) workloads.

In particular, low latency and hard real time (e.g., interrupt latency) are critical in many edge use cases (e.g., VNFs, 4G/5G base stations), but they can be difficult to guarantee even with a carefully configured platform. For example, edge applications, and 5G in particular, typically have very strict packet and interrupt latency requirements. Moreover, there are many factors that impact the interrupt latency, such as the host configuration, kernel configuration, VM configuration, isolation techniques, and so forth.

For example, as explained above, a host system or CPU often has numerous power configurations (e.g., P-states, C-states, dynamic frequency scaling modes) that can be configured to optimize the performance of a workload depending on the workload type, requirements, and/or use case. In some cases, for example, workloads may integrate shallow C-states in a race-to-idle scenario to achieve higher performance per watt (e.g., a 10% improvement in some cases). In other cases, workloads may integrate deep C-states to achieve higher power savings, but since deep C-states can add latency, provisioning C-states can be problematic for latency-sensitive workloads and may have a negative overall impact on their performance.

The power modes mentioned above, along with many other platform configuration parameters, are pre-selected on a platform before a workload is deployed. As a result, real-time interrupt latency—which changes with the traffic conditions—cannot always be guaranteed.

Thus, in the illustrated deployment lifecycle 100, a test or lead container with a representative workload and/or a collection of test tools—referred to as a canary container—is placed on the platform before the platform is deployed in a data center cluster or pool on which the actual workload is hosted. For example, the canary container may be deployed on the platform using multiple possible platform configurations, and for each configuration, the test tools in the canary container are executed to stress the platform resources and measure various performance metrics or KPIs on the platform.

In some cases, for example, the platform may be tested to verify whether hard real-time and/or low-latency packet processing can be achieved in stressed conditions when the platform is configured using various power and performance modes (e.g., with power-saving features enabled/disabled, performance/frequency boosting features enabled/disabled).

At the end of the test, a decision is made on whether to place the platform in a data center cluster or pool with live traffic based on whether any of the tested platform configurations are able to satisfy the latency and power requirements in the SLA. Moreover, in addition to a simple “go” or “no go” decision, a detailed report can be provided with test results for the best configurations along with flags to identify where certain results are possibly “out of spec” (e.g., outside the requirements of the workload/SLA).

As an example, cyclictest is a tool that may be used to test timer interrupt latencies in some embodiments. For real-time workloads, cyclictest is a Linux benchmark that measures the amount of time that passes between when a timer expires and when the thread which set the timer runs. It does this by taking a time snapshot just prior to setting a timer for a specified time interval (t₁), taking another time snapshot after the timer finishes (t₂), and then comparing the theoretical wakeup time with the actual wakeup time (t₂−(t₁+sleep_time)). The resulting value represents the latency for the wakeup of that timer.

Running cyclictest for a sufficient period of time with real traffic can be useful to determine the interrupt latency of the available power configurations/conditions and identify which of them is best suited for a particular workload in a real-time traffic condition. However, running cyclictest for only a short period of time and without creating appropriate real-time stress conditions is not useful, since the execution of an asynchronous event from idle state is usually quite fast on any system (even non-real-time systems).

The challenge is to minimize the latency when reacting to an asynchronous event, irrespective of what code path is executed at the time the external event arrives. Therefore, specific stress conditions must be present while cyclictest is running to reliably determine the worst-case latency of a given system. In some embodiments, the described solution leverages known stressors like stress-ng to provide these stress conditions. Stress-ng can be used to stress test a computer system in various selectable ways, including floating point, integer, bit manipulation, control flow, and most importantly thermal overruns. By running both cyclictest and stress-ng simultaneously at each available power setting, the best power mode that delivers the required minimum interrupt latency can be identified, and that mode can then be selected when a workload is deployed for a real-time traffic condition.

In a multi-tenant use case, for example, a base frequency boosting mode (e.g., Intel® Speed Select Base Frequency (SST-BF)) can help reduce interrupt latency by running a certain number of cores at a higher frequency to execute higher priority tasks and running a few cores at a lower frequency to execute low priority tasks. The low frequency cores might result in higher interrupt latency if packets must switch between the cores, however, so other power modes may be more effective at reducing latency in those cases. Similarly, if the workload is not multi-tenant but rather multiple instances of the exact same task, a turbo frequency boosting mode (e.g., Intel® Turbo Boost) may be more effective for reducing latency.

An edge computing system can host any of these workloads and can also change dynamically at runtime due to virtualization, such as when more tenants are deployed at runtime. Thus, in order to avoid an increase in interrupt latency when a workload is actually deployed on the host platform, the platform may be automatically reconfigured at runtime based on a verified configuration derived using the described solution.

The described platform verification functionality and/or canary containers can be implemented by or using any suitable type or combination of hardware and/or software components. In some embodiments, for example, canary containers may be implemented or used by an orchestration system for performing workload deployments (e.g., Kubernetes, OpenStack). For example, the platform verification functionality and/or canary containers can be implemented as a new operator construct in an orchestration system such as Kubernetes. Alternatively, the platform verification functionality and/or canary containers can be implemented using initialization (init) containers in an orchestration system such as Kubernetes. For example, a Kubernetes Pod may include an init container that deploys a canary container on a platform to verify the platform configuration prior to deployment of a workload.

FIGS. 2-3 illustrate examples of various processor frequency scaling modes that may be evaluated and/or verified using the described solution. In particular, FIG. 2 illustrates a graph 200 of the frequencies of processor cores for various power modes of a multi-core processor (e.g., a CPU). In the illustrated example, the frequencies of the cores are shown for the following power modes or configurations of the processor:
(i) Turbo mode 201;
(ii) Base frequency mode on 202; and
(iii) Base frequency mode off 203.

Turbo mode 201 may refer to a mode that automatically directs additional frequency to some or all processor cores when needed for demanding workloads (e.g., Intel® Turbo Boost technology). In the illustrated example, when turbo mode 201 is turned on, all cores are running at the maximum turbo frequency.

Base frequency mode 202 may refer to a mode that increases the base frequency of certain high-priority cores while reducing the base frequency of other cores (e.g., Intel® Speed Select Base Frequency (SST-BF) technology). In this manner, cores running high-priority or demanding workloads can run at a guaranteed higher base frequency than other cores running lower-priority workloads.

In the illustrated example, when base frequency mode is turned on 202, certain cores are running at a higher base frequency than other cores. However, when base frequency mode is turned off 203, all cores are running at the same base frequency.

FIG. 3 illustrates an example 300 of various power modes for allocating surplus frequency to the cores of a multi-core processor 302 (e.g., a CPU). In the illustrated example, the processor 302 is shown in three different power states 310a-c.

In the first state 310a, a power control unit (PCU) 304 distributes a minimum frequency (e.g., assigned by the OS) to each core 308a-d of the processor 302. In this example, however, a surplus of frequency/power 306 is still available after the minimum frequency has been allocated to the respective cores 308a-d. Moreover, the processor 302 supports various modes for allocating the surplus frequency among the cores 308a-d. For example, the surplus frequency can be allocated across the cores 308a-d uniformly, or the surplus frequency can be allocated across the cores 308a-d non-uniformly (e.g., based on priority).

If the processor 302 is configured to allocate the surplus frequency uniformly, the PCU 304 allocates the available frequency/power 306 evenly across the cores 308a-d to achieve a uniform increase in frequency for each core 308a-d. In some cases, for example, this mode may be used when no high-priority workloads are running on the cores 308a-d and/or when all workloads have the same priority. In the illustrated example, this mode is depicted in processor state 310b.

If the processor 302 is configured to allocate the surplus frequency non-uniformly, however, the PCU 304 prioritizes the allocation of surplus frequency to certain core(s) 308a-d. In some embodiments, for example, the processor 302 may support a mode that allocates surplus frequency based on priorities or weights assigned to the respective cores 308a-d (e.g., Intel® Speed Select Technology Core Power (SST-CP)). In particular, the OS or VMM may assign a weight to each core 308a-d based on the relative priority of the workload running on each core. For example, a core running a high-priority workload may be assigned a larger weight than a core running a low-priority workload. In some embodiments, the weights are assigned to the cores 308a-d from the interval [0,1], such that the sum of all weights adds up to one (w₀+w₁+ . . . +wₙ=1). In this manner, when a surplus of frequency is available, the PCU 304 distributes the surplus frequency based on the weights assigned to the respective cores 308a-d. For example, the surplus frequency allocated to a particular core 308a-d can be computed by multiplying the weight assigned to that core with the total surplus frequency.

In the illustrated example, this priority-based frequency allocation mode is depicted in processor state 310c. In particular, core 308a is running a high-priority workload, while the other cores 308b-d are running low-priority workloads. Thus, core 308a is assigned a weight of 1, while the other cores 308b-d are assigned weights of 0. In this manner, the entire surplus frequency is allocated to core 308a, which is running the high-priority workload.

In other cases, however, the surplus frequency can be distributed across the cores 308a-d in any suitable manner based on the priority, compute requirements, and/or performance objectives of the respective workloads (e.g., by simply adjusting the weights assigned to each core).

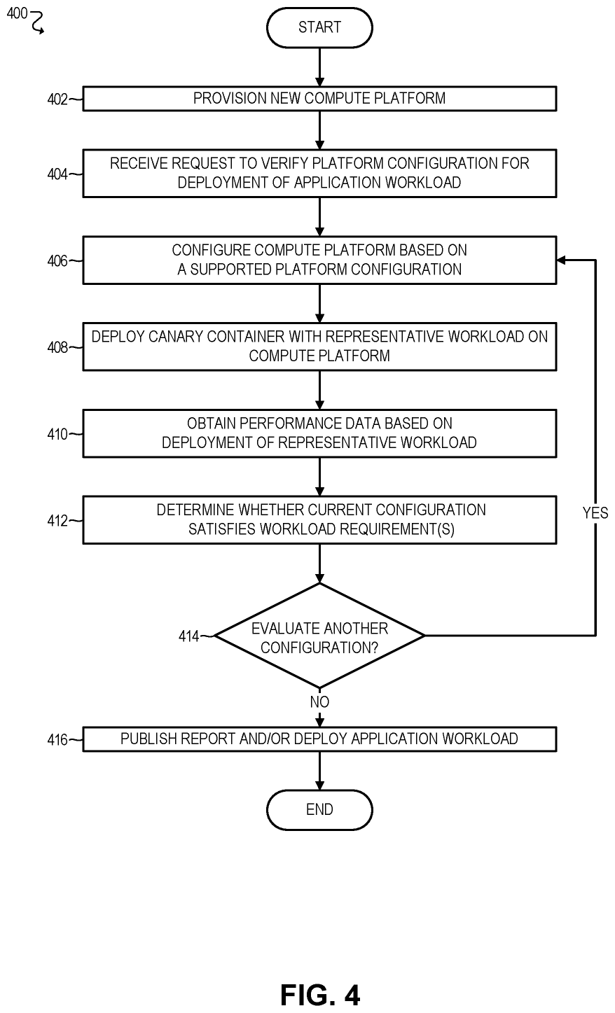

FIG. 4 illustrates a flowchart 400 for automatically verifying platform configurations for a workload deployment in accordance with certain embodiments. In some embodiments, for example, flowchart 400 may be implemented and/or performed by or using the computing devices, systems, and/or platforms described throughout this disclosure.

The flowchart begins at block 402 by provisioning a new compute platform. In some cases, for example, a sysadmin may initially set up or configure a new compute platform, which will subsequently be added to a cluster of platforms or servers in a data center or other computing infrastructure (e.g., cloud data centers, edge data centers, distributed computing infrastructures) for workload deployments.

The compute platform may be or may include any type of computing device with any type or combination of computing resources, such as CPUs, GPUs, FPGAs, accelerators, memory, storage devices, network interface controllers, and so forth.

The flowchart then proceeds to block 404, where a request is received to evaluate or verify potential platform configurations for deployment of an application workload on the compute platform. In some embodiments, the request may be initiated and/or received by one or more components of an orchestration system. For example, in some cases, the request may be part of or associated with (e.g., implicitly or explicitly) a request to add the platform to a cluster or pool of platforms and/or deploy an application workload on the platform or the cluster.

The application workload may include any workload associated with an application hosted on the platform or cluster. In some cases, for example, the application workload may be or may include a virtual network function (VNF) and/or network function virtualization (NFV) workload.

Moreover, in some cases, the application workload may have one or more workload requirements (e.g., defined in an SLA and/or specified in a workload profile) associated with deployment of the workload. For example, the workload requirement(s) may include one or more requirements relating to interrupt performance (e.g., hardware interrupt and/or timer interrupt latency), packet and network performance (e.g., packet latency, packet jitter, packet loss, network bandwidth/throughput), compute resource requirements (e.g., required resource types and/or capacities), compute performance, and/or power-related performance (e.g., power consumption, compute performance per watt, power state transition latency/exit latency for CPU power states), among other examples.

Moreover, the compute platform may support a variety of platform configurations and/or configuration options. For example, the various hardware components and resources of the compute platform may support multiple power and/or performance configurations, such as various power management states (e.g., P-states or C-states of a CPU), frequency scaling modes, and so forth.

For example, the frequency scaling modes may be used to statically or dynamically scale or boost an operating frequency of one or more processing units of the compute platform, such as CPU cores, GPU cores, FPGAs, hardware accelerators, and so forth. In various embodiments, for example, a “processing unit” may include or encompasses a processor or CPU, processor or CPU core, graphics processing unit (GPU), GPU core, hardware accelerator, field programmable gate array, neural network processing unit, artificial intelligence processing unit, inference engine, data processing unit, and/or infrastructure processing unit, among other examples.

In some embodiments, for example, the frequency scaling modes may include:
(i) a turbo frequency mode to configure the operating frequency of one or more processing units based on a maximum operating frequency;
(ii) a base frequency mode to configure the operating frequency of one or more processing units based on a base operating frequency; and/or
(iii) a priority frequency mode to configure the operating frequency of one or more processing units based on an assigned priority of the processing units.

The power configurations and/or frequency scaling modes may also include one or more uncore frequency scaling modes to configure an operating frequency of “uncore” processor components, such as a cache, a memory controller, and/or an interconnect controller associated with the CPU, among other examples.

Moreover, the request received at block 404 may seek to verify which of the platform configurations supported by the compute platform are capable of satisfying the workload requirement(s) of the application workload.

Thus, the flowchart then proceeds to block 406 to select one of the supported platform configurations to evaluate and configure the compute platform based on the selected configuration.

The flowchart then proceeds to block 408 to deploy a canary container with a representative workload on the compute platform based on the selected platform configuration currently under evaluation.

The representative workload may include any workload or combination of workloads that are representative of the application workload. For example, the representative workload may be designed, configured, or implemented to stress the resources of the compute platform in a manner that is similar to, or representative of, the actual application workload to be deployed on the platform.

In some embodiments, for example, the representative workload may include (i) one or more stress tests to stress one or more resources of the compute platform, and/or (ii) one or more performance tests to test one or more performance metrics of the compute platform. For example, the performance test(s) may include a latency test (e.g., to test timer interrupt latency, packet latency, or power state transition latency), a jitter test, compute performance test, or a power consumption test, among other examples.

Additionally, or alternatively, the representative workload may include the actual application workload deployed in a test mode (e.g., based on test data rather than live traffic).

The flowchart then proceeds to block 410, to monitor, track, and/or obtain performance data for the current platform configuration based on the deployment of the representative workload on the compute platform. The performance data may include any performance or telemetry data (e.g., performance metrics or key performance indicators (KPIs)) captured during or based on the deployment of the representative workload on the platform under the current platform configuration.

The flowchart then proceeds to block 412 to determine, based on the performance data, whether the current configuration satisfies the workload requirement(s). In some embodiments, for example, the performance metrics or KPIs captured for the representative workload based on the current platform configuration may be compared to the workload requirements specified in the SLA and/or workload profile for the application workload. If the performance metrics or KPIs are within the workload requirements, then it may be determined that the current configuration satisfies the workload requirements. Otherwise, it may be determined that the current configuration does not satisfy (e.g., partially or fully) the workload requirements.

The flowchart then proceeds to block 414 to determine whether to evaluate another configuration. In various embodiments, for example, all of the supported platform configurations may be evaluated, or only a subset of supported platform configurations may be evaluated. For example, in some embodiments, some or all of the supported platform configurations may be evaluated and subsequently ranked based on their respective performance. Alternatively, or additionally, some or all of the supported platform configurations may be initially ordered based on priority or preference (e.g., prioritized based on energy efficiency), and those configurations may be evaluated successively until identifying at lest one configuration that satisfies the workload requirements. For example, if a primary or preferred configuration is determined not to satisfy the workload requirements, then one or more secondary configurations may then be evaluated successively until identifying one that satisfies the workload requirements.

If there are other configuration(s) that need to be evaluated, the flowchart cycles back through blocks 406-412 to select the next configuration to evaluate and configure the compute platform based on that configuration, deploy/execute the canary container and/or representative workload on the compute platform under the current configuration, monitor/obtain performance data during deployment/execution of the representative workload, and determine whether the current configuration satisfies the workload requirement(s) based on the performance data. The flowchart continues in this manner until determining at block 414 that no additional configurations need to be evaluated.

In this manner, the canary container and/or representative workload is deployed on the compute platform using one or more possible configurations, performance data is obtained for each configuration based on deployment of the representative workload, and a determination is made as to whether the performance of each configuration satisfies the workload requirements.

The flowchart then proceeds to block 416 to publish a report with the results of the performance evaluation and/or deploy the application workload on the compute platform based on the report. For example, the report may indicate the performance metrics captured for each configuration during deployment/execution of the representative workload, whether each configuration satisfies the workload requirements (e.g., go or no go), which configurations provide optimal performance in view of the performance metrics and the workload requirements, and so forth.

In this manner, a system administrator and/or the orchestration software may use the report to (i) determine whether to deploy the workload on the compute platform, (ii) select an optimal configuration for deploying the workload on the compute platform, and/or (iii) deploy the workload on the compute platform based on the optimal configuration.

At this point, the flowchart may be complete. In some embodiments, however, the flowchart may restart and/or certain blocks may be repeated. For example, in some embodiments, the flowchart may restart and/or repeat certain blocks in order to evaluate additional configurations of the compute platform, evaluate configurations of the compute platform for a new application workload, and/or evaluate configurations of another newly provisioned compute platform.

### EXAMPLE COMPUTING PLATFORMS AND ENVIRONMENTS

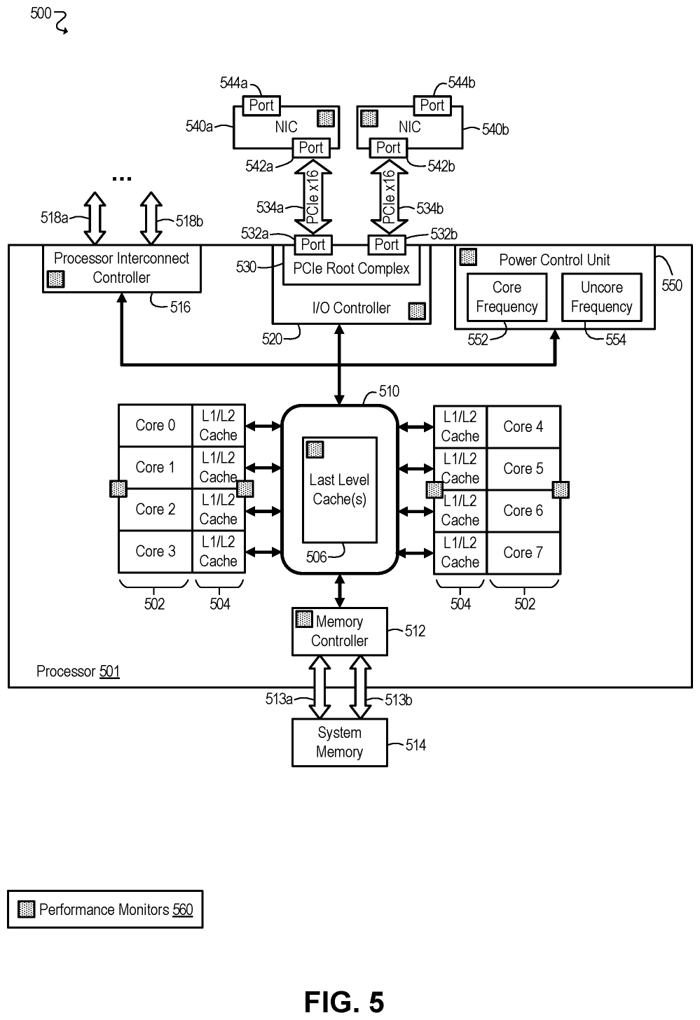

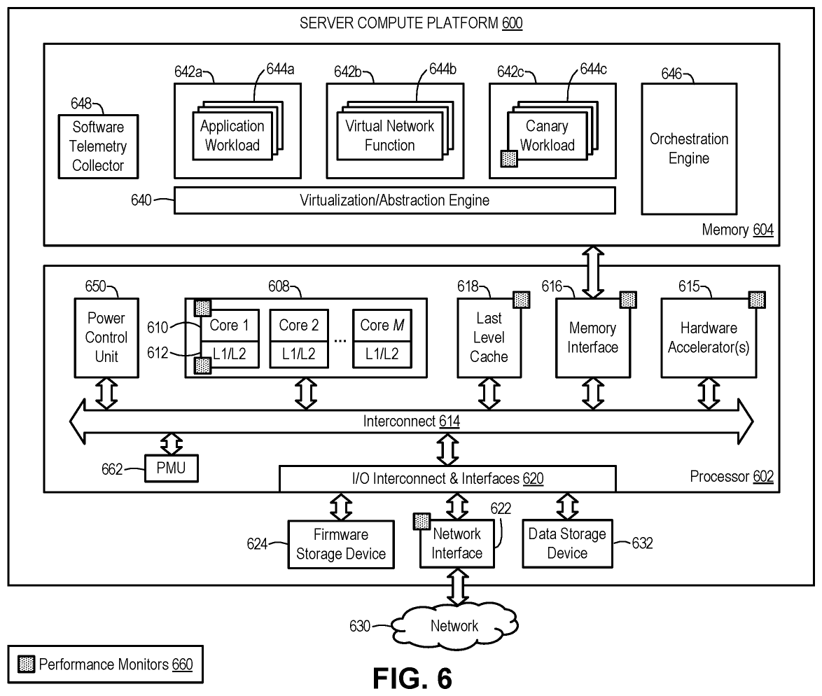

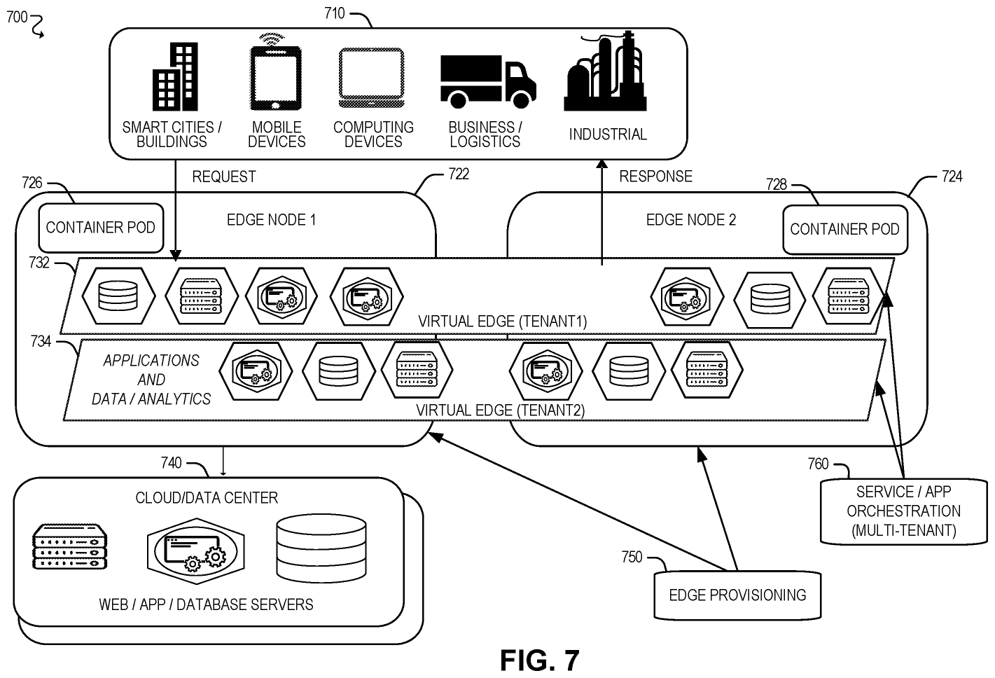

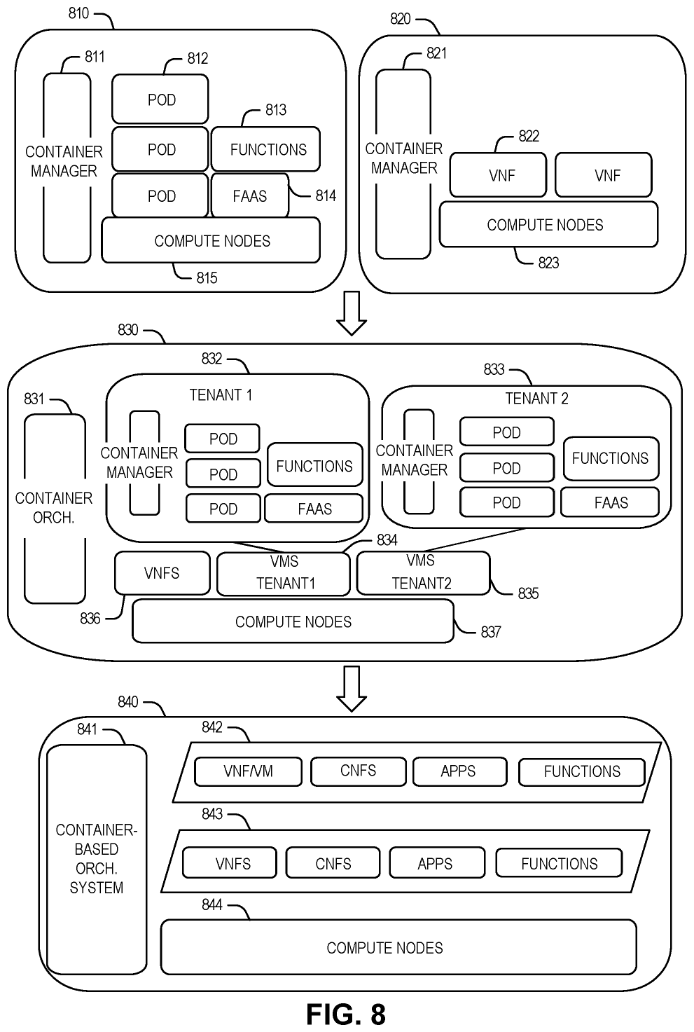

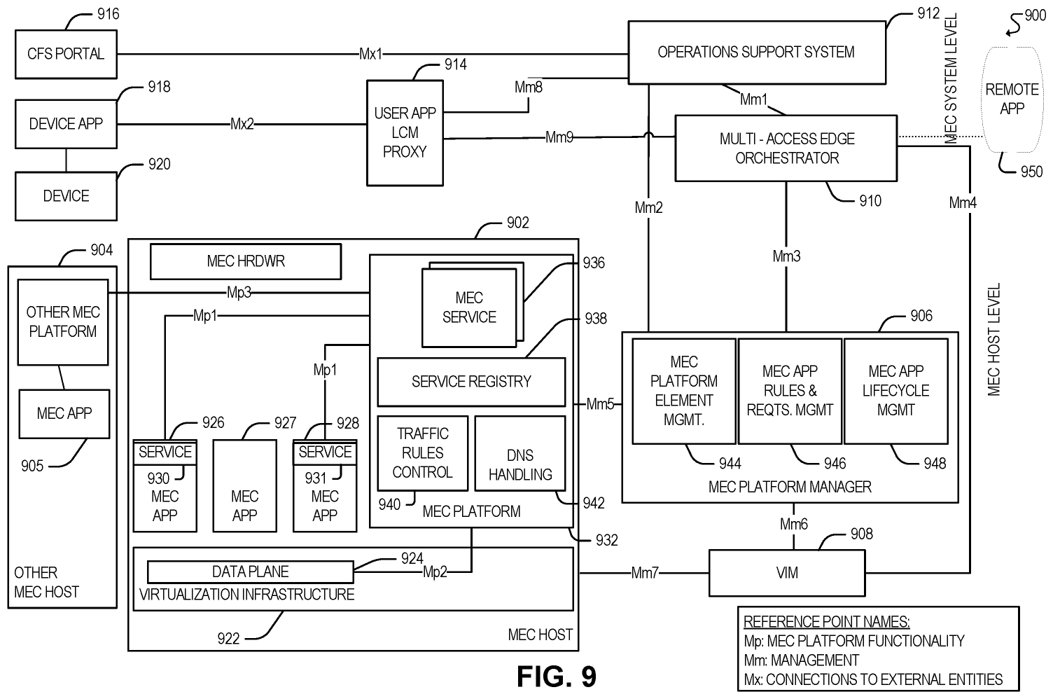

The following figures present examples of computing platforms and environments that may be used to implement the functionality described throughout this disclosure. In some embodiments, for example, the illustrated computing platforms and environments (e.g., processor platform 500 of FIG. 5, server platform 600 of FIG. 6, edge computing system 700 of FIG. 7, system arrangements 810, 820 of FIG. 8, and/or MEC architecture 900 of FIG. 9) may be used to orchestrate/deploy workloads across a cluster of computing platforms in a data center (e.g., a cloud or edge data center) based on verified platform configurations. Alternatively, or additionally, workloads may be orchestrated/deployed on the hardware resources of the illustrated computing platforms and environments based on verified platform configurations.

FIG. 5 illustrates an example of a multi-core processor platform 500, which may be used to implement certain aspects of the embodiments and functionality described throughout this disclosure. In some embodiments, processor platform 500 may be implemented as a System on a Chip (SoC).

In the illustrated embodiment, processor platform 500 includes a multi-core processor 501, which includes multiple processor cores 502 (labeled Core 0-Core 7). Each processor core 502 includes associated Level 1 (L1) and/or Level 2 (L2) caches 504, and the cores 502 are also coupled to one or more Last Level Caches (LLCs) 506.

Processor 501 also includes a memory controller 512, a point-to-point processor interconnect controller 516, and an input/output (I/O) controller 520.

The memory controller 512 is used to access system memory 514 via one or more memory channels 513a-b.

The point-to-point processor interconnect controller 516 communicates over interconnect links 518a-b (e.g., an Ultra Path Interconnect (UPI)) with other platform components, such as other processors in a multiprocessor system (not shown).

The I/O controller 520 is configured to perform I/O interface operations similar to those performed by an I/O chip or chipset in a conventional Northbridge/Southbridge platform architecture. In some embodiments, for example, rather than have these functions performed by a separate chip or chipset coupled to a processor via an external interconnect, they may be implemented by circuitry and logic embedded on the processor package (e.g., SoC) itself, which may support substantially higher bandwidths than available with conventional external interconnects, among other advantages.

In the illustrated embodiment, the I/O controller 520 includes a PCIe Root Complex 530 with PCIe root ports 532a-b. PCIe root ports 532a-b provide PCIe interfaces to PCIe x16 links 534a-b, which are respectively connected to PCIe ports 542a-b of network interface controllers (NICs) 540a-b, which in turn include network ports 544a-b for communicating over a network (e.g., sending/receiving streams of packets over a network).

Processor 501 further includes a power control unit (PCU) 550, a core frequency control block 552, an uncore frequency control block 554, and a plurality of performance monitor (PMON) blocks 558. Power control unit 550 is used to manage power aspects of processor 501, including configuring the processor in different power states. Core frequency control block 552 is used to control the frequency/voltage of the core portion of the circuitry in processor 501, which includes the processor cores 502. In some embodiments, the LLC(s) 506 are operated using the core frequency. Under other architectures, the LLC(s) 506 are considered part of the uncore. The remainder of the processor circuitry may be considered part of the uncore, and its frequency is controlled by uncore frequency controller 554. As is known, this does not imply that all of the circuitry in the uncore portion of the processor circuitry operates at the same frequency, as processor typically include frequency dividers that are used to operator some (circuit) blocks at lower frequencies than other blocks. For illustrative purposes, core frequency control block 552 and uncore frequency control block 554 are depicted as separate block, while in practice that may be implemented in other blocks, such as in PCU 550.

PMON blocks 558 are distributed throughout processor 501 and are used to collect various telemetry data associated with the blocks in which the PMON blocks as shown. Generally, telemetry data collected from PMON blocks 558 may be exposed by software (e.g., via an Application Program Interface (API) or the like) running on the system to enable other software to obtain the telemetry data. Telemetry data may also be collected from cores 502 and from one or more I/O devices, such as NICs 540a-b. Software-based telemetry data may also be used in some embodiments.

The components of processor 501 (e.g., processor cores 502, L1/L2 caches 504, LLC(s) 506, memory controller 512, I/O controller 520, processor interconnect 516, PCU 550) are interconnected via one or more interconnects 510, which may be implemented using any type or combination of interconnect structures or technologies, such as ring interconnects with multiple nodes, interconnect fabrics (e.g., a 2D mesh interconnect), point-to-point interconnects (e.g., UPI, PCIe, Intel on-chip System Fabric (IOSF), Open Core Protocol (OCP)), buses, and so forth.

The processor platform 500 may be embodied as any type of engine, device, or collection of devices capable of performing various compute functions. In some examples, the platform 500 may be embodied as a single device such as an integrated circuit, an embedded system, a field-programmable gate array (FPGA), a system-on-a-chip (SOC), or other integrated system or device.

The processor 501 may be embodied as any type of processor capable of performing the functions described herein (e.g., executing an application). For example, the processor 501 may be embodied as a multi-core processor(s), a microcontroller, a processing unit, a specialized or special purpose processing unit, or other processor or processing/controlling circuit.

In some examples, the processor 501 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 501 may work in coordination with each other to execute many types of operations and instructions within and on behalf of the platform 500.

The memory 514 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 514 may be integrated into the processor 501. The memory 514 may store various software and data used during operation such as one or more applications, data operated on by the application(s), libraries, and drivers.

The network interface controllers (NICs) 540a-b may be embodied as any communication circuit, device, or collection thereof, capable of enabling communications over a network between the platform 500 and another compute device or platform. The NICs 540a-b may be configured to use any one or more communication technologies (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The NICs 540a-b may also be referred to, or may include, a host fabric interface (HFI). In some embodiments, a NIC 540 may be embodied as one or more add-in-boards, daughter cards, network interface cards, controller chips, chipsets, or other devices that may be used by the platform 500 to connect with another compute device or platform. In some examples, the NIC 540 may be embodied as part of a system-on-a-chip (SoC) that includes one or more processors, or included on a multichip package that also contains one or more processors. In some examples, the NIC 540 may include a local processor (not shown) and/or a local memory (not shown) that are both local to the NIC 540. In such examples, the local processor of the NIC 540 may be capable of performing one or more of the functions of the platform 500 described herein. Additionally, or alternatively, in such examples, the local memory of the NIC 540 may be integrated into one or more components of the platform at the board level, socket level, chip level, and/or other levels.

FIG. 6 illustrates an example of a server computing platform 600, which may be used to implement certain aspects of the embodiments and functionality described throughout this disclosure.

Platform 600 includes a combination of hardware and software components. For example, the platform hardware includes a processor 602 having an SoC architecture including core circuitry 608 with M processor cores 610, each coupled to a Level 1 and Level 2 (L1/L2) cache 612. Each of the processor cores and L1/L2 caches are connected to an interconnect 614 to which a memory interface 616, a last level cache (LLC) 618, and one or more hardware accelerators 615 are also coupled, forming a coherent memory domain. Interconnect 614 is an abstracted representation of various types of interconnects including ring interconnects and mesh interconnects. Memory interface 616 is used to access host memory 604 in which various software components are loaded and run via execution of associated software instructions on processor cores 610.

Hardware accelerator(s) 615 are special-purpose processor(s) designed to accelerate certain types of workloads, such as machine learning (ML) and/or artificial intelligence (AI), video/graphics processing, single instruction multiple data (SIMD) (e.g., vector) operations, security operations (e.g., cryptography), infrastructure acceleration (e.g., networking, virtualization), and so forth. In the illustrated embodiment, hardware accelerator(s) 615 are integrated with processor 602 (e.g., implemented on the same chip). In other embodiments, however, some or all hardware accelerator(s) 615 may be external to processor 602 (e.g., implemented on a different chip) and may be communicatively coupled to processor 602 via an interface (e.g., I/O interconnect 620). In various embodiments, hardware accelerator(s) 615 may be implemented as processors, co-processors, FPGAs, ASICs, and/or any other suitable combination of hardware and/or software logic.

Processor 602 further includes an input/output (I/O) interconnect hierarchy, which includes one or more levels of interconnect circuitry and interfaces that are collectively depicted as I/O interconnect & interfaces 620 for simplicity. Various components and peripheral devices are coupled to processor 602 via respective interfaces (not all separately shown), including a network interface 622, a data storage device 632, and a firmware storage device 624. In one embodiment, firmware storage device 624 is connected to I/O interconnect via a link, such as an Enhanced Serial Peripheral Interface Bus (eSPI).

Network interface 622 is connected to a network 630, such as a local area network (LAN), private network, or similar network within a data center, and/or a wide area network (WAN) (e.g., the Internet). For example, various types of data center architectures may be supported including architectures employing server platforms interconnected by network switches such as Top-of-Rack (ToR) switches, as well as disaggregated architectures such as Intel® Corporation's Rack Scale Design architecture.

The data storage device 632 is used to store data and/or software used by platform 600. Optionally, all or a portion of the software used to implement the software aspects of embodiments herein may be loaded over a network 630 accessed by network interface 622. The data storage device(s) 632 may be embodied as any type of device, or combination of devices, configured for short-term or long-term storage of data such as, for example, memory devices and circuits, memory cards, hard disk drives, solid-state drives, or other data storage devices and/or controllers.

A power control unit (PCU) 650 is used to manage the power configurations for hardware components of platform 600, such as dynamically adjusting the frequency/voltage of processor cores 610, hardware accelerators 615, caches 612/618, and so forth.

In the illustrated example, various software components are running on platform 600 (e.g., executing on one or more processor cores 610), as depicted by the contents of the host memory 604. The illustrated software components include a virtualization/abstraction engine 640, an orchestration engine 646, and a software telemetry collector 648.

The virtualization/abstraction engine 640 provides virtualized environments 642a-c for workload deployments 644a-c on platform 600. For example, the virtualization/abstraction engine 640 may include a hypervisor/virtual machine manager (VMM) (e.g., a Type-1 (bare metal) or Type-2 hypervisor/VMM), and the virtualized environments 642a-c may include virtual machines hosted by the hypervisor/VMM. Alternatively, or additionally, the virtualization/abstraction engine 640 may include a container engine, and the virtualized environments 642a-c may include containers (e.g., Docker®-type containers) and/or pods (e.g., Kubernetes Pods) hosted by the container engine and/or the orchestration engine 646.

Moreover, the workloads 644 deployed in the virtualized environments 642a-c (e.g., VMs/containers) may include application workloads 644a, virtual network function (VNF) workloads 644b, and/or canary workloads 644c (e.g., a representative workload 644c deployed in a canary container 642c to verify the platform configuration for a particular application workload), among other examples.

The orchestration engine 646 (e.g., Kubernetes, Docker Swarm) may be used to orchestrate/deploy the workloads 644a-c on platform 600 and/or on other computing platforms in a cluster.

The platform 600 also includes various mechanisms for monitoring, collecting, and/or generating telemetry data, including a performance monitoring unit (PMU) 662, a collection of hardware-based performance monitors (PMONs) 660, and a software-based telemetry collector 648 to collect telemetry/performance metrics at the software level.

Examples of telemetry data include but are not limited to processor core telemetry data, hardware accelerator telemetry data, cache-related telemetry data, memory-related telemetry data, network telemetry data, power data, and/or software or workload telemetry data. The cache-related telemetry data may include but is not limited to Cache Monitoring Technology (CMT), Cache Allocation Technology (CAT), and Code and Data Prioritization (CDP) telemetry data. CMT monitors LLC utilization by individual threads, applications, VMs, VNFs, etc. CMT improves workload characterization, enables advanced resource-aware scheduling decisions, aids “noisy neighbor” detection and improves performance debugging. CAT enables software-guided redistribution of cache capacity, enabling VMs, containers or applications to benefit from improved cache capacity and reduced cache contention. CDP is an extension of CAT that enables separate control over code and data placement in the LLC. Certain specialized types of workloads may benefit with increased runtime determinism, enabling greater predictability in application performance. In one embodiment, one of the PMONs 660 implements Memory Bandwidth Monitoring (MBM). MBM enables multiple VMs, VNFs, or applications to be tracked independently, which provides memory bandwidth monitoring for each running thread simultaneously. Benefits include detection of noisy neighbors, characterization and debugging of performance for bandwidth-sensitive applications, and more effective non-uniform memory access (NUMA)-aware scheduling.

FIG. 7 illustrates deployment and orchestration for virtualized and container-based edge configurations across an edge computing system operated among multiple edge nodes and multiple tenants (e.g., users, providers) which use such edge nodes. Specifically, FIG. 7 depicts coordination of a first edge node 722 and a second edge node 724 in an edge computing system 700, to fulfill requests and responses for various client endpoints 710 (e.g., smart cities/building systems, mobile devices, computing devices, business/logistics systems, industrial systems, etc.), which access various virtual edge instances. Here, the virtual edge instances 732, 734 provide edge compute capabilities and processing in an edge cloud, with access to a cloud/data center 740 for higher-latency requests for websites, applications, database servers, etc. However, the edge cloud enables coordination of processing among multiple edge nodes for multiple tenants or entities.

In the example of FIG. 7, these virtual edge instances include: a first virtual edge 732, offered to a first tenant (Tenant 1), which offers a first combination of edge storage, computing, and services; and a second virtual edge 734, offering a second combination of edge storage, computing, and services. The virtual edge instances 732, 734 are distributed among the edge nodes 722, 724, and may include scenarios in which a request and response are fulfilled from the same or different edge nodes. The configuration of the edge nodes 722, 724 to operate in a distributed yet coordinated fashion occurs based on edge provisioning functions 750. The functionality of the edge nodes 722, 724 to provide coordinated operation for applications and services, among multiple tenants, occurs based on orchestration functions 760.

It should be understood that some of the devices in 710 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 722, 724 may operate as security feature enforcement points for local resources allocated to multiple tenants per node. Additionally, tenant runtime and application execution (e.g., in instances 732, 734) may serve as an enforcement point for a security feature that creates a virtual edge abstraction of resources spanning potentially multiple physical hosting platforms. Finally, the orchestration functions 760 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, Servlets, servers, or other computation abstraction that may be partitioned according to a DICE layering and fan-out structure to support a RoT context for each. Accordingly, the respective RoTs spanning devices 710, 722, and 740 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 7. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 722, 724 may implement the use of containers, such as with the use of a container “pod” 726, 728 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 732, 734 are partitioned according to the needs of each container.

With the use of container pods, a pod controller oversees the partitioning and allocation of containers and resources. The pod controller receives instructions from an orchestrator (e.g., orchestrator 760) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 760 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

FIG. 8 illustrates additional compute arrangements deploying containers in an edge computing system. As a simplified example, system arrangements 810, 820 depict settings in which a pod controller (e.g., container managers 811, 821, and container orchestrator 831) is adapted to launch containerized pods, functions, and functions-as-a-service instances through execution via compute nodes (815 in arrangement 810), or to separately execute containerized virtualized network functions through execution via compute nodes (823 in arrangement 820). This arrangement is adapted for use of multiple tenants in system arrangement 830 (using compute nodes 837), where containerized pods (e.g., pods 812), functions (e.g., functions 813, VNFs 822, 836), and functions-as-a-service instances (e.g., FaaS instance 814) are launched within virtual machines (e.g., VMs 834, 835 for tenants 832, 833) specific to respective tenants (aside the execution of virtualized network functions). This arrangement is further adapted for use in system arrangement 840, which provides containers 842, 843, or execution of the various functions, applications, and functions on compute nodes 844, as coordinated by an container-based orchestration system 841.

The system arrangements of depicted in FIG. 8 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 8, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

FIG. 9 illustrates a mobile edge system reference architecture (or MEC architecture) 900, such as is indicated by ETSI MEC specifications. FIG. 9 specifically illustrates a MEC architecture 900 with MEC hosts 902 and 904 providing functionalities in accordance with the ETSI GS MEC-003 specification. In some embodiments, MEC architecture 900 may leverage the automated platform verification functionality described throughout this disclosure (e.g., to deploy workloads of MEC apps 926-928 (e.g., NFVs) across resources of the virtualization infrastructure 922 of MEC hosts 902, 904 based on verified platform configurations).

Referring to FIG. 9, the MEC network architecture 900 can include MEC hosts 902 and 904, a virtualization infrastructure manager (VIM) 908, an MEC platform manager 906, an MEC orchestrator 910, an operations support system 912, a user app proxy 914, a UE app 918 running on UE 920, and CFS portal 916. The MEC host 902 can include a MEC platform 932 with filtering rules control component 940, a DNS handling component 942, a service registry 938, and MEC services 936. The MEC services 936 can include at least one scheduler, which can be used to select resources for instantiating MEC apps (or NFVs) 926, 927, and 928 upon virtualization infrastructure 922. The MEC apps 926 and 928 can be configured to provide services 930 and 931, which can include processing network communications traffic of different types associated with one or more wireless connections (e.g., connections to one or more RAN or telecom-core network entities). The MEC app 905 instantiated within MEC host 904 can be similar to the MEC apps 926-7728 instantiated within MEC host 902. The virtualization infrastructure 922 includes a data plane 924 coupled to the MEC platform via an MP2 interface. Additional interfaces between various network entities of the MEC architecture 900 are illustrated in FIG. 9.

The MEC platform manager 906 can include MEC platform element management component 944, MEC app rules and requirements management component 946, and MEC app lifecycle management component 948. The various entities within the MEC architecture 900 can perform functionalities as disclosed by the ETSI GS MEC-003 specification.

In some aspects, the remote application (or app) 950 is configured to communicate with the MEC host 902 (e.g., with the MEC apps 926-928) via the MEC orchestrator 910 and the MEC platform manager 906.

The flows described in the figures herein are merely representative of operations that may occur in particular embodiments. In other embodiments, additional operations may be performed by the components of the various systems described herein. Various embodiments of the present disclosure contemplate any suitable mechanisms for accomplishing the functions described herein. Some of the operations illustrated in the figures may be repeated, combined, modified or deleted where appropriate. Additionally, operations may be performed in any suitable order without departing from the scope of particular embodiments.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disk may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

A module as used herein or as depicted in the figures refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the flows described or functionality of the various systems or components described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g. reset, while an updated value potentially includes a low logical value, e.g. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A machine-accessible/readable medium includes any mechanism that provides (e.g., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

### EXAMPLES

The following examples pertain to embodiments in accordance with this disclosure.

Example 1 includes at least one non-transitory machine-readable storage medium having instructions stored thereon, wherein the instructions, when executed on processing circuitry, cause the processing circuitry to: receive a request to evaluate a plurality of platform configurations for deployment of an application workload on a compute platform, wherein the application workload is to be deployed based on one or more workload requirements; deploy a representative workload on the compute platform based on the plurality of platform configurations, wherein the representative workload is representative of the application workload; obtain performance data for the plurality of platform configurations, wherein the performance data is obtained based on deploying the representative workload on the compute platform; and determine, based on the performance data, whether the plurality of platform configurations satisfy the one or more workload requirements.

Example 2 includes the storage medium of Example 1, wherein the plurality of platform configurations comprise a plurality of power configurations of a central processing unit (CPU) of the compute platform.

Example 3 includes the storage medium of Example 2, wherein the plurality of power configurations comprise one or more CPU power management states, wherein the one or more CPU power management states comprise: one or more P-states of the CPU; or one or more C-states of the CPU.

Example 4 includes the storage medium of Example 2, wherein the plurality of power configurations comprise one or more frequency scaling modes, wherein the one or more frequency scaling modes are to dynamically scale an operating frequency of one or more processing units of the CPU.

Example 5 includes the storage medium of Example 4, wherein the one or more frequency scaling modes comprise: a turbo frequency mode, wherein the turbo frequency mode is to configure the operating frequency of the one or more processing units based on a maximum operating frequency; a base frequency mode, wherein the base frequency mode is to configure the operating frequency of the one or more processing units based on a base operating frequency; or a priority frequency mode, wherein the priority frequency mode is to configure the operating frequency of the one or more processing units based on an assigned priority of the one or more processing units.

Example 6 includes the storage medium of Example 1, wherein the instructions that cause the processing circuitry to deploy the representative workload on the compute platform based on the plurality of platform configurations further cause the processing circuitry to: deploy a canary container on the compute platform, wherein the representative workload is to be executed in the canary container.

Example 7 includes the storage medium of Example 1, wherein the representative workload comprises the application workload deployed in a test mode.

Example 8 includes the storage medium of Example 1, wherein the representative workload comprises: one or more stress tests to stress one or more resources of the compute platform; and one or more performance tests to test one or more performance metrics of the compute platform.

Example 9 includes the storage medium of Example 8, wherein: the one or more workload requirements comprise a latency requirement, a jitter requirement, or a power consumption requirement; and the one or more performance tests comprise a latency test, a jitter test, or a power consumption test.

Example 10 includes the storage medium of Example 9, wherein the latency test is to test a timer interrupt latency, a packet latency, or a power state transition latency.

Example 11 includes the storage medium of Example 1, wherein the application workload comprises a virtual network function workload.

Example 12 includes a method, comprising: receiving a request to evaluate a plurality of platform configurations for deployment of an application workload on a compute platform, wherein the application workload is to be deployed based on one or more workload requirements; deploying a representative workload on the compute platform based on the plurality of platform configurations, wherein the representative workload is representative of the application workload; obtaining performance data for the plurality of platform configurations, wherein the performance data is obtained based on deploying the representative workload on the compute platform; and determining, based on the performance data, whether the plurality of platform configurations satisfy the one or more workload requirements.

Example 13 includes the method of Example 12, wherein the plurality of platform configurations comprise one or more power management states of a central processing unit (CPU) of the compute platform, wherein the one or more power management states comprise: one or more P-states of the CPU; or one or more C-states of the CPU.

Example 14 includes the method of Example 12, wherein the plurality of platform configurations comprise one or more frequency scaling modes of a central processing unit (CPU) of the compute platform, wherein the one or more frequency scaling modes are to dynamically scale an operating frequency of one or more processing units of the CPU, wherein the one or more frequency scaling modes comprise: a turbo frequency mode, wherein the turbo frequency mode is to configure the operating frequency of the one or more processing units based on a maximum operating frequency; a base frequency mode, wherein the base frequency mode is to configure the operating frequency of the one or more processing units based on a base operating frequency; or a priority frequency mode, wherein the priority frequency mode is to configure the operating frequency of the one or more processing units based on an assigned priority of the one or more processing units.

Example 15 includes the method of Example 12, wherein the representative workload comprises: one or more stress tests to stress one or more resources of the compute platform; and one or more performance tests to test one or more performance metrics of the compute platform.

Example 16 includes the method of Example 15, wherein: the one or more workload requirements comprise a latency requirement, a jitter requirement, or a power consumption requirement; and the one or more performance tests comprise a latency test, a jitter test, or a power consumption test.

Example 17 includes a computing device comprising processing circuitry to: receive a request to evaluate a plurality of platform configurations for deployment of an application workload on a compute platform, wherein the application workload is to be deployed based on one or more workload requirements; deploy a representative workload on the compute platform based on the plurality of platform configurations, wherein the representative workload is representative of the application workload; obtain performance data for the plurality of platform configurations, wherein the performance data is obtained based on deploying the representative workload on the compute platform; and determine, based on the performance data, whether the plurality of platform configurations satisfy the one or more workload requirements.

Example 18 includes the computing device of Example 17, wherein the plurality of platform configurations comprise one or more power management states of a central processing unit (CPU) of the compute platform, wherein the one or more power management states comprise: one or more P-states of the CPU; or one or more C-states of the CPU.

Example 19 includes the computing device of Example 17, wherein the plurality of platform configurations comprise one or more frequency scaling modes of a central processing unit (CPU) of the compute platform, wherein the one or more frequency scaling modes are to dynamically scale an operating frequency of one or more processing units of the CPU, wherein the one or more frequency scaling modes comprise: a turbo frequency mode, wherein the turbo frequency mode is to configure the operating frequency of the one or more processing units based on a maximum operating frequency; a base frequency mode, wherein the base frequency mode is to configure the operating frequency of the one or more processing units based on a base operating frequency; or a priority frequency mode, wherein the priority frequency mode is to configure the operating frequency of the one or more processing units based on an assigned priority of the one or more processing units.

Example 20 includes the computing device of Example 17, wherein the representative workload comprises: one or more stress tests to stress one or more resources of the compute platform; and one or more performance tests to test one or more performance metrics of the compute platform.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. At least one non-transitory machine-readable storage medium having instructions stored thereon, wherein the instructions, when executed on processing circuitry, cause the processing circuitry to:
receive a request to evaluate a plurality of platform configurations for deployment of an application workload on a compute platform, wherein the application workload is to be deployed based on one or more workload requirements;
deploy a representative workload on the compute platform based on the plurality of platform configurations, wherein the representative workload is representative of the application workload;
obtain performance data for the plurality of platform configurations, wherein the performance data is obtained based on deploying the representative workload on the compute platform; and
determine, based on the performance data, whether the plurality of platform configurations satisfy the one or more workload requirements.

2. The storage medium of claim 1, wherein the plurality of platform configurations comprise a plurality of power configurations of a central processing unit (CPU) of the compute platform.

3. The storage medium of claim 2, wherein the plurality of power configurations comprise one or more CPU power management states, wherein the one or more CPU power management states comprise:
one or more P-states of the CPU; or
one or more C-states of the CPU.

4. The storage medium of claim 2, wherein the plurality of power configurations comprise one or more frequency scaling modes, wherein the one or more frequency scaling modes are to dynamically scale an operating frequency of one or more processing units of the CPU.

5. The storage medium of claim 4, wherein the one or more frequency scaling modes comprise:
a turbo frequency mode, wherein the turbo frequency mode is to configure the operating frequency of the one or more processing units based on a maximum operating frequency;
a base frequency mode, wherein the base frequency mode is to configure the operating frequency of the one or more processing units based on a base operating frequency; or
a priority frequency mode, wherein the priority frequency mode is to configure the operating frequency of the one or more processing units based on an assigned priority of the one or more processing units.

6. The storage medium of claim 1, wherein the instructions that cause the processing circuitry to deploy the representative workload on the compute platform based on the plurality of platform configurations further cause the processing circuitry to:
deploy a canary container on the compute platform, wherein the representative workload is to be executed in the canary container.

7. The storage medium of claim 1, wherein the representative workload comprises the application workload deployed in a test mode.

8. The storage medium of claim 1, wherein the representative workload comprises:
one or more stress tests to stress one or more resources of the compute platform; and
one or more performance tests to test one or more performance metrics of the compute platform.

9. The storage medium of claim 8, wherein:
the one or more workload requirements comprise a latency requirement, a jitter requirement, or a power consumption requirement; and
the one or more performance tests comprise a latency test, a jitter test, or a power consumption test.

10. The storage medium of claim 9, wherein the latency test is to test a timer interrupt latency, a packet latency, or a power state transition latency.

11. The storage medium of claim 1, wherein the application workload comprises a virtual network function workload.

12. A method, comprising:
receiving a request to evaluate a plurality of platform configurations for deployment of an application workload on a compute platform, wherein the application workload is to be deployed based on one or more workload requirements;
deploying a representative workload on the compute platform based on the plurality of platform configurations, wherein the representative workload is representative of the application workload;
obtaining performance data for the plurality of platform configurations, wherein the performance data is obtained based on deploying the representative workload on the compute platform; and
determining, based on the performance data, whether the plurality of platform configurations satisfy the one or more workload requirements.

13. The method of claim 12, wherein the plurality of platform configurations comprise one or more power management states of a central processing unit (CPU) of the compute platform, wherein the one or more power management states comprise:
one or more P-states of the CPU; or
one or more C-states of the CPU.

14. The method of claim 12, wherein the plurality of platform configurations comprise one or more frequency scaling modes of a central processing unit (CPU) of the compute platform, wherein the one or more frequency scaling modes are to dynamically scale an operating frequency of one or more processing units of the CPU, wherein the one or more frequency scaling modes comprise:
a turbo frequency mode, wherein the turbo frequency mode is to configure the operating frequency of the one or more processing units based on a maximum operating frequency;
a base frequency mode, wherein the base frequency mode is to configure the operating frequency of the one or more processing units based on a base operating frequency; or
a priority frequency mode, wherein the priority frequency mode is to configure the operating frequency of the one or more processing units based on an assigned priority of the one or more processing units.

15. The method of claim 12, wherein the representative workload comprises:
one or more stress tests to stress one or more resources of the compute platform; and
one or more performance tests to test one or more performance metrics of the compute platform.

16. The method of claim 15, wherein:
the one or more workload requirements comprise a latency requirement, a jitter requirement, or a power consumption requirement; and
the one or more performance tests comprise a latency test, a jitter test, or a power consumption test.

17. A computing device comprising processing circuitry to:
receive a request to evaluate a plurality of platform configurations for deployment of an application workload on a compute platform, wherein the application workload is to be deployed based on one or more workload requirements;
deploy a representative workload on the compute platform based on the plurality of platform configurations, wherein the representative workload is representative of the application workload;
obtain performance data for the plurality of platform configurations, wherein the performance data is obtained based on deploying the representative workload on the compute platform; and
determine, based on the performance data, whether the plurality of platform configurations satisfy the one or more workload requirements.

18. The computing device of claim 17, wherein the plurality of platform configurations comprise one or more power management states of a central processing unit (CPU) of the compute platform, wherein the one or more power management states comprise:
one or more P-states of the CPU; or
one or more C-states of the CPU.

19. The computing device of claim 17, wherein the plurality of platform configurations comprise one or more frequency scaling modes of a central processing unit (CPU) of the compute platform, wherein the one or more frequency scaling modes are to dynamically scale an operating frequency of one or more processing units of the CPU, wherein the one or more frequency scaling modes comprise:
a turbo frequency mode, wherein the turbo frequency mode is to configure the operating frequency of the one or more processing units based on a maximum operating frequency;
a base frequency mode, wherein the base frequency mode is to configure the operating frequency of the one or more processing units based on a base operating frequency; or
a priority frequency mode, wherein the priority frequency mode is to configure the operating frequency of the one or more processing units based on an assigned priority of the one or more processing units.

20. The computing device of claim 17, wherein the representative workload comprises:
one or more stress tests to stress one or more resources of the compute platform; and
one or more performance tests to test one or more performance metrics of the compute platform.
